(19) United States
(12) Patent Application Publication
(10) Pub. No.: US 2025/0005419 A1
(43) Pub. Date: Jan. 2, 2025

(54) APPARATUS AND METHOD FOR ENSURING INTEGRITY OF QUANTUM COMPUTER

(71) Applicant: Korea University Research and Business Foundation, Seoul (KR)

(72) Inventors: Seokhie HONG, Seoul (KR); Donggun LEE, Gwacheon-si (KR)

(21) Appl. No.: 18/750,724

(22) Filed: Jun. 21, 2024

(30) Foreign Application Priority Data
Jun. 23, 2023 (KR) 10-2023-0081176

(51) Int. Cl. G06N 10/40; G06N 10/60

(52) U.S. Cl. CPC G06N 10/40; G06N 10/60

(57) ABSTRACT

A method for ensuring the integrity of a quantum computer, which is performed by a computing device including the quantum computer according to some embodiments of the present disclosure may include: performing an operation for at least one first qubit initialized, by using a first quantum circuit including at least one quantitative gate to obtain a first quantum state including first quantum information for each of the at least one first qubit; and composing first quantum states obtained for the at least one first qubit, respectively into one by using a second quantum circuit that composes the first quantum states obtained for the at least one first qubit, respectively into one to generate a first hash qubit including the first quantum states composed into one as a hash value.

### CROSS-REFERENCE TO RELATED APPLICATIONS

This application claims priority to and the benefit of Korean Patent Application No. 10-2023-0081176 filed in the Korean Intellectual Property Office on Jun. 23, 2023, the entire contents of which are incorporated herein by reference.

### TECHNICAL FIELD

The present disclosure relates to a method and an apparatus for ensuring the integrity of a quantum computer, and more particularly, to a method for ensuring the integrity as evidence of a quantum computer for quantum forensic of analyzing quantum evidence, and a quantum hash system configuration described as a quantum circuit performing the same.

### BACKGROUND ART

A quantum computer can be a computer that processes data by using phenomena related to quantum mechanics such as quantum entanglement, quantum superposition, etc. The quantum entanglement may mean a state in which two or more states are connected to each other, so that they cannot be handled separately in each state. The quantum superposition may mean that various result states by measurement are simultaneously present probabilistically before measuring the quantum state.

A minimum unit of the quantum computer as a qubit can indicate 0, 1, or a superposition state unlike a bit of a class computer. A calculation model of the quantum computer is called quantum circuit, and the quantum circuit can be a set of N (here, N is a natural number) qubits and a series of quantum gates acting on the qubits.

Digital Forensics refers to a series of tasks such as collection, analysis, and report creation, etc., to submit, to a judicial organization, digital evidences, such as electronic information while maintaining an evidence capability in a classical computer system. Unlike physical evidence dealt with in general events, various science and technology are being used for digital evidence analysis in consideration of the characteristics of electronic information such as large capacity, cloning easiness, and requirement of expert knowledge for selection.

A hash can be a function of mapping any bitstream to a fixed length of bitstream while satisfying two properties it is computationally impossible to find one input to be mapped to one given output and it is computationally impossible to find another input to be mapped to the same output with respect to one given input.

In the digital forensics, the hash is used to ensure the integrity of the digital evidence for the evidence capability in a court according to characteristics of the hash. A hash value is generated with the fixed length of bitstream for each digital evidence, which shows that the digital evidence is collected, and then not manipulated.

However, in the quantum computer system, information that uses and processes the qubit, not the bit, is quantum information, not electronic information. In order to submit, to the judicial organization, the quantum evidence, such as the quantum information on the quantum computer while maintaining the evidence capability, a new quantum forensics considering a remarkable technical difference between the classical system and the quantum system is required.

### SUMMARY OF THE INVENTION

The present disclosure is contrived in response to the above-described background art, and has been made in an effort to provide an apparatus and a method for ensuring the integrity of a quantum computer.

Technical objects of the present disclosure are not restricted to the technical object mentioned as above. Other unmentioned technical objects will be apparently appreciated by those skilled in the art by referencing the following description.

In order to achieve the object, a method for ensuring the integrity of a quantum computer, which is performed by a computing device including the quantum computer according to some embodiments of the present disclosure may include: performing an operation for at least one first qubit initialized, by using a first quantum circuit including at least one quantitative gate to obtain a first quantum state including first quantum information for each of the at least one first qubit; and composing first quantum states obtained for the at least one first qubit, respectively into one by using a second quantum circuit that composes the first quantum states obtained for at least one first qubit, respectively into one to generate a first hash qubit including the first quantum states composed into one as a hash value.

Alternatively, the first quantum information may include information on a spin for each of the at least one first qubit.

Alternatively, the first quantum information may include information on an operation result accumulated by an operation through the at least one quantum gate with respect to each of the at least one first qubit.

Alternatively, the method may further include: obtaining a first rotation value from the composed first quantum state included in the first hash qubit by using a predetermined first rotation algorithm; and validating the first hash qubit based on whether the first rotation value and a predetermined first ground truth value correspond to each other.

Alternatively, the first predetermined first ground truth value may be determined as 0 or 1 based on the predetermined first rotation algorithm.

Alternatively, the method may further include: performing an operation for at least one second qubit initialized, by using the first quantum circuit to obtain a second quantum state including second quantum information for each of the at least one second qubit; and composing second quantum states obtained for the at least one second qubit, respectively into one by using the second quantum circuit that composes the second quantum states obtained for the at least one second qubit, respectively into one to generate a second hash qubit including the second quantum states composed into one as the hash value, and the at least one first qubit and the at least one second qubit may not be in an entangled state with each other.

Alternatively, the method may further include composing the first hash qubit and the second hash qubit into one by using a third quantum circuit that composes the composed first quantum state and the composed second quantum state into one to generate a composed hash qubit including the composed first quantum state and the composed second quantum state as the hash value.

Alternatively, the second quantum circuit and the third quantum circuit may correspond to each other.

Alternatively, the method may further include: obtaining a second rotation value from the composed first quantum state and the composed second quantum state included in the composed hash qubit by using a predetermined second rotation algorithm; and validating the composed hash qubit based on whether the second rotation value and a predetermined second ground truth value correspond to each other.

Alternatively, the predetermined second ground truth value may be determined as 0 or 1 based on the predetermined second rotation algorithm.

Alternatively, the second quantum circuit may connect a third qubit and the first quantum states obtained for the at least one first qubit, respectively by using at least one quantum state to compose the first quantum states obtained for the at least one first qubit, respectively into one.

Alternatively, another embodiment of the present disclosure provides a computer program storing non-transitory computer readable storage medium, wherein the computer program comprises instructions for causing a processor of a computing device including a quantum computer to perform the following steps for ensuring the integrity for the quantum computer in which the steps may include: performing an operation for at least one first qubit initialized, by using a first quantum circuit including at least one quantitative gate to obtain a first quantum state including first quantum information for each of the at least one first qubit; and composing first quantum states obtained for the at least one first qubit, respectively into one by using a second quantum circuit that composes the first quantum states obtained for the at least one first qubit, respectively into one to generate a first hash qubit including the first quantum states composed into one as a hash value.

Alternatively, yet another embodiment provides a computing device including a quantum computer, for ensuring the integrity of the quantum computer, which may include: a processor; and a memory, in which the processor may perform an operation for at least one first qubit initialized, by using a first quantum circuit including at least one quantitative gate to obtain a first quantum state including first quantum information for each of the at least one first qubit, and compose first quantum states obtained for the at least one first qubit, respectively into one by using a second quantum circuit that composes the first quantum states obtained for the at least one first qubit, respectively into one to generate a first hash qubit including the first quantum states composed into one as a hash value.

According to an exemplary embodiment of the present disclosure, an apparatus and a method for ensuring the integrity of a quantum computer can be provided.

Effects which can be acquired in the present disclosure are not limited to the aforementioned effects and other unmentioned effects will be clearly understood by those skilled in the art from the following description.

### BRIEF DESCRIPTION OF THE DRAWINGS

Various aspects are now described with reference to the drawings and like reference numerals are generally used to designate like elements. In the following exemplary embodiments, for purposes of explanation, numerous specific details are set forth to provide a comprehensive understanding of one or more aspects. However, it will be apparent that the aspect(s) can be executed without the detailed matters.

FIG. 1 is a diagram illustrating a computing device for ensuring the integrity of a quantum computer according to an embodiment of the present disclosure.

FIG. 2 is a flowchart illustrating a method for ensuring the integrity of a quantum computer, which is performed by a computing device according to an embodiment of the present disclosure.

FIG. 3A is a diagram related to a first quantum circuit for ensuring the integrity of a quantum computer by the computing device according to an embodiment of the present disclosure.

FIG. 3B is a diagram related to a first set of the first quantum circuit for ensuring the integrity of a quantum computer by the computing device according to an embodiment of the present disclosure.

FIG. 4 is a diagram related to the first quantum circuit and a second quantum circuit for ensuring the integrity of a quantum computer by the computing device according to an embodiment of the present disclosure.

FIG. 5 is a flowchart illustrating a validation process of a hash qubit for ensuring the integrity of a quantum computer, which is performed by the computing device according to an embodiment of the present disclosure.

FIG. 6 is a diagram related to the first quantum circuit and a third quantum circuit for ensuring the integrity of a quantum computer by the computing device according to an embodiment of the present disclosure.

FIG. 7 is a diagram related to a first quantum circuit and a third quantum circuit for ensuring the integrity of a quantum computer by a computing device according to another embodiment of the present disclosure.

FIG. 8A is a diagram related to a first quantum circuit and a third quantum circuit for ensuring the integrity of a quantum computer by a computing device according to yet another embodiment of the present disclosure.

FIG. 8B is a diagram related to a second set of the first quantum circuit for ensuring the integrity of a quantum computer by the computing device according to yet another embodiment of the present disclosure.

FIG. 9 is a diagram related to a first quantum circuit and the third quantum circuit for ensuring the integrity of a quantum computer by the computing device according to yet another embodiment of the present disclosure.

FIG. 10 is a diagram related to a process of generating a composite hash qubit for ensuring the integrity of a quantum computer by the computing device according to an embodiment of the present disclosure.

FIG. 11 illustrates a simple and general schematic view of an exemplary computing environment in which the exemplary embodiments of the present disclosure may be implemented.

### DETAILED DESCRIPTION

Various embodiments will now be described with reference to drawings. In the present specification, various descriptions are presented to provide appreciation of the present disclosure. However, it is apparent that the embodiments can be executed without the specific description.

“Component”, “module”, “system”, and the like which are terms used in the specification refer to a computer-related entity, hardware, firmware, software, and a combination of the software and the hardware, or execution of the software. For example, the component may be a processing executed on a processor, the processor, an object, an execution thread, a program, and/or a computer, but is not limited thereto. For example, both an application executed in a computing device and the computing device may be the components. One or more components may reside within the processor and/or an execution thread. One component may be localized in one computer. One component may be distributed between two or more computers. Further, the components may be executed by various computer-readable media having various data structures, which are stored therein. The components may perform communication through local and/or remote processing according to a signal (for example, data transmitted from another system through a network such as the Internet through data and/or a signal from one component that interacts with other components in a local system and a distribution system) having one or more data packets, for example.

In addition, the term “or” is intended to mean not exclusive “or” but implicit “or”. That is, when not separately specified or not clear in terms of a context, a sentence “X uses A or B” is intended to mean one of the natural inclusive replacements. That is, the sentence “X uses A or B” may be applied to any of the case where X uses A, the case where X uses B, or the case where X uses both A and B. Further, it should be understood that the term “and/or” used in this specification designates and includes all available combinations of one or more items among enumerated related items.

Further, it should be appreciated that the term “comprise” and/or “comprising” means presence of corresponding features and/or components. However, it should be appreciated that the term “comprises” and/or “comprising” means that presence or addition of one or more other features, components, and/or a group thereof is not excluded. Further, when not separately specified or it is not clear in terms of the context that a singular form is indicated, it should be construed that the singular form generally means “one or more” in this specification and the claims.

In addition, the term “at least one of A or B” should be interpreted to mean “a case including only A”, “a case including only B”, and “a case in which A and B are combined”.

Those skilled in the art need to recognize that various illustrative logical blocks, configurations, modules, circuits, means, logic, and algorithm steps described in connection with the embodiments disclosed herein may be additionally implemented as electronic hardware, computer software, or combinations of both sides. To clearly illustrate the interchangeability of hardware and software, various illustrative components, blocks, configurations, means, logic, modules, circuits, and steps have been described above generally in terms of their functionalities. Whether the functionalities are implemented as the hardware or software depends on a specific application and design restrictions given to an entire system. Skilled artisans may implement the described functionalities in various ways for each particular application. However, such implementation decisions should not be interpreted as causing a departure from the scope of the present disclosure.

The description of the presented embodiments is provided so that those skilled in the art of the present disclosure use or implement the present disclosure. Various modifications to the embodiments will be apparent to those skilled in the art. Generic principles defined herein may be applied to other embodiments without departing from the scope of the present disclosure. Therefore, the present disclosure is not limited to the embodiments presented herein. The present disclosure should be analyzed within the widest range which is coherent with the principles and new features presented herein.

In the present disclosure, terms represented by N-th such as first, second, or third are used for distinguishing at least one entity. For example, entities expressed as first and second may be the same as each other or different from each other.

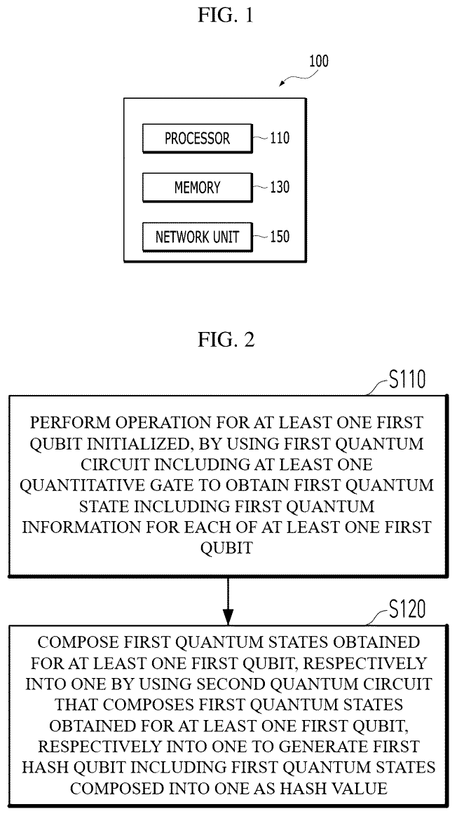

FIG. 1 is a diagram illustrating a computing device for ensuring the integrity of a quantum computer according to some embodiments of the present disclosure.

In the present disclosure, the computing device 100 may mean an arbitrary type server or user terminal constituting a system for implementing exemplary embodiments of the present disclosure.

In an embodiment, the computing device 100 may mean a quantum computing device (e.g., a quantum computer, etc.) that performs a calculation by using quantum mechanical physical phenomena such as indexing information expression of quantum superposition and a parallel operation using quantum entanglement.

The computing device 100 may include a processor 110, a memory 130, and a network unit 150. The processor 110 may be constituted by one or more cores and may include processors for data analysis and quantum processing, which include a central processing unit (CPU), a general purpose graphics processing unit (GPGPU), a tensor processing unit (TPU), and the like of the computing device. The processor 110 may control an overall operation of the computing device 100. For example, the processor 110 may process signals, data information, etc., input or output through components included in the computing device 100. As another example, the processor 110 may read a computer program stored in the memory 130 to perform the quantum processing according to an embodiment of the present disclosure.

According to some embodiments of the present disclosure, the memory 130 may store any type of information generated or determined by the processor 110 or any type of information received by the network unit 150.

According to some exemplary embodiments of the present disclosure, the memory 130 may include at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The computing device 100 may operate in connection with a web storage performing a storing function of the memory 130 on the Internet. The description of the memory is just an example and the present disclosure is not limited thereto.

The network unit 150 according to some exemplary embodiments of the present disclosure may include an arbitrary wired/wireless communication network that may transmit/receive arbitrary type data and signals. The techniques described in this specification may also be used in other networks in addition to the aforementioned networks.

FIG. 2 is a flowchart illustrating a method for ensuring the integrity of a quantum computer, which is performed by a computing device according to some embodiments of the present disclosure.

Steps illustrated in FIG. 2 are exemplary steps. Therefore, it will also be apparent to those skilled in the art that some of the steps of FIG. 2 may be omitted or there may be additional steps within a range without departing from a spirit scope of the present disclosure. Further, specific contents regarding the components (e.g., the computing apparatus 100, etc.) disclosed in FIG. 2 may be replaced with the contents described through FIG. 1 above. The steps illustrated in FIG. 2 may be performed, for example, by the computing device 100.

Referring to FIG. 2, the processor 110 of the computing device 100 performs an operation for at least one first qubit initialized, by using a first quantum circuit including at least one quantitative gate to obtain a first quantum state including first quantum information for each of the at least one first qubit (S110).

The first quantum circuit may include at least one initialized first qubit, at least one quantum gate acting on at least one initialized first qubit, and/or a measurement.

The qubit (e.g., a first qubit, a second qubit, a third qubit, etc.) may be a basic unit of information for processing data using a phenomenon related to quantum mechanics. The qubit may simultaneously express values corresponding to various bits by using the quantum superposition state. For example, the qubit may express respective values as probabilities such as ‘0 with a probability of 20% and 1 with a probability of 80%’. The qubit may be determined as one state while the quantum superposition (entangled) state is released when being measured (observed). For example, the qubit starts in a basis state indicating a state of |0 [symbol] or |1 [symbol] , and may show a state changed by a quantum gate. In addition, the qubit may be determined as the state of |0 [symbol] or |1 [symbol] when being measured (observed). The qubit may be expressed by a 2-dimensional vector.

At least one quantum gate may be an element indicating an operation applied to the qubit in the quantum computer. At least one quantum gate may convert the quantum state of the qubit.

At least one quantum gate may be operated by a matrix multiplication of complex vectors. At least one quantum gate may include at least one of a NOT gate, a Hadamard gate, a Pauli gate, a Phaseshift gate (e.g., an S gate, a T gate, etc.), a CNOT gate, a CZ gate, and/or a SWAP gate.

The NOT gate may perform an operation of inverting the state of the qubit. For example, when the state of the qubit is |0 [symbol] , the NOT gate may convert |0 [symbol] into |1 [symbol] . As another example, when the state of the qubit is |1 [symbol] , the NOT gate may convert |1 [symbol] into |0 [symbol] . A logic symbol of the NOT gate may be

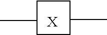

in the quantum circuit. A matrix equation of the NOT gate may be

$$[ \begin{matrix}0 & 1 \\ 1 & 0\end{matrix} ] .$$

The Hadamard gate may be a gate that makes the state of the qubit which is the state of |0 [symbol] or |1 [symbol] into a superposition state in which |0 [symbol] and |1 [symbol] are simultaneously present. A logic symbol of the Hadamard gate may be

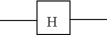

in the quantum circuit. A matrix equation of the Hadamard gate may be

$$\frac{1}{\sqrt{2}} [ \begin{matrix}0 & 1 \\ 1 & 0\end{matrix} ] .$$

The Pauli gate may include a Pauli-X gate, a Pauli-Y gate, and a Pauli-Z gate.

The Pauli-X gate may be a gate that rotates the state of the qubit around an X axis. The Pauli-X gate may perform an operation of inverting the state of the qubit. The Pauli-X gate may correspond to the NOT gate. A logic symbol of the Pauli-X gate may be

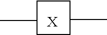

in the quantum circuit. A matrix equation of the Pauli-X gate may be

$$[ \begin{matrix}0 & 1 \\ 1 & 0\end{matrix} ] .$$

The Pauli-Y gate may be a gate that rotates the state of the qubit around a Y axis. The Pauli-Y gate may perform an operation of inverting the state of the qubit, and assigning a negative symbol to a complex coefficient. A logic symbol of the Pauli-Y gate may be

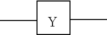

in the quantum circuit. A matrix equation of the Pauli-Y gate may be

$$[ \begin{matrix}0 & - i \\ i & 0\end{matrix} ] .$$

i may be an imaginary unit.

The Pauli-Z gate may be a gate that rotates the state of the qubit around a Z axis. The Pauli-Z gate may perform an operation of changing a sign of the state with respect to the state of the qubit. A logic symbol of the Pauli-Z gate may be

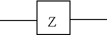

in the quantum circuit. A matrix equation of the Pauli-Z gate may be

$$[ \begin{matrix}1 & 0 \\ 0 & - 1\end{matrix} ] .$$

The Phaseshift gate may be a gate that changes a phase of the qubit. The Phaseshift gate may include an S gate, a T gate, etc.

The S gate may be a gate that performs an operation of bringing a phase change of 90 degrees to the qubit. A logic symbol of the S gate may be

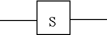

in the quantum circuit. A matrix equation of the S gate may be

$$[ \begin{matrix}1 & 0 \\ 0 & i\end{matrix} ] .$$

i may be the imaginary unit.

The T gate may be a gate that performs an operation of bringing a phase change of 45 degrees to the qubit. A logic symbol of the T gate may be

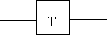

in the quantum circuit. A matrix equation of the T gate may be

$$[ \begin{matrix}1 & 0 \\ 0 & {e}^{i π / 4}\end{matrix} ] .$$

i may be the imaginary unit. e^{iπ/4} as a complex number calculated according to the Euler's formula may be a complex number corresponding to an angle of 45 degrees on a complex plane.

A CNOT gate and/or a CZ gate may be a gate that makes two qubits to the entangled state.

The CNOT gate may be a gate that performs a NOT gate operation for a second qubit (target qubit) when a first qubit (control qubit) is |1 [symbol] . A logic symbol of the CNOT gate may be

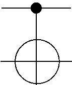

in the quantum circuit. • may be the control qubit and ⊕ may be the target qubit. A matrix equation of the CNOT gate may be

$$[ \begin{matrix}1 & 0 & 0 & 0 \\ 0 & 1 & 0 & 0 \\ 0 & 0 & 0 & 1 \\ 0 & 0 & 1 & 0\end{matrix} ] .$$

The CZ gate may be a gate that performs a Pauli-Z gate operation for the second qubit (target qubit) when the first qubit (control qubit) is |1 [symbol] . A logic symbol of the CZ gate may be

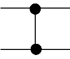

in the quantum circuit. Here, upper • may be the control qubit and lower • may be the target qubit. A matrix equation of the CZ gate may be

$$[ \begin{matrix}1 & 0 & 0 & 0 \\ 0 & 1 & 0 & 0 \\ 0 & 0 & 1 & 0 \\ 0 & 0 & 0 & - 1\end{matrix} ] .$$

The SWAP gate may be a gate that exchanges states of both qubits with each other. A logic symbol of the SWAP gate may be

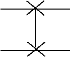

in the quantum circuit. A matrix equation of the SWAP gate may be

$$[ \begin{matrix}1 & 0 & 0 & 0 \\ 0 & 0 & 1 & 0 \\ 0 & 1 & 0 & 0 \\ 0 & 0 & 0 & 1\end{matrix} ] .$$

However, the type of quantum gate is not limited thereto and may include various quantum gates.

The measurement may be a process of separating the state of the qubit into one of the basis states, and obtaining a measurement result through the separated state. For example, the processor 110 performs the measurement for the state of the qubit in the Z basis state in the quantum circuit to obtain the state |0 [symbol] or |1 [symbol] . When the measured state of the qubit is the state of |0 [symbol] , the processor 110 may determine the corresponding state as 0 as a classical bit. When the measured state of the qubit is the state of |1 [symbol] , the processor 110 may determine the corresponding state as 1 as the classical bit. A symbol of the measurement may be

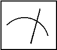

in the quantum circuit.

Meanwhile, the quantum state (e.g., a first quantum state, a second quantum state, etc.) may include quantum information for indicating the state of the qubit (e.g., the first qubit, the second qubit, the third qubit, etc.). The quantum state may be expressed as in Equation 1 below, for example.

$$Quantum state \vert ψ 〉 = α \vert 0 〉 + β \vert 1 〉 ( α , β ∈ ℂ ) \qquad [ Equation 1 ]$$

In Equation 1, |0 [symbol] represents a vector that represents a basis state in which the state of the qubit is ‘0’, |1 [symbol] represents a vector that represents a basis state in which the state of the qubit is ‘1’, α represents a coefficient that represents a probability that ‘0’ will be measured in the quantum state of the qubit, β represents a coefficient that represents a probability that ‘1’ will be measured in the quantum state of the qubit, and [symbol] may mean a complex number or a complex set.

The quantum information (e.g., first quantum information, second quantum information, etc.) may include information on a spin for each of at least one qubit (e.g., the first qubit, the second qubit, etc.).

The spin may be a quantum numerical value indicating internal rotationality of the qubit. The spin may be represented through a Bloch sphere. The Bloch sphere may be a tool for visually representing the state of the qubit. The Bloch sphere may have a sphere shape in a 3D space, and the surface of the sphere may mean the state of the qubit. The Bloch sphere may represent the state of the qubit with one point on the Bloch sphere. For example, an upper extreme point on the Bloch sphere may indicate the |0 [symbol] state of the qubit, and a lower extreme point may indicate the |1 [symbol] state of the qubit.

The quantum information (e.g., first quantum information, second quantum information, etc.) may include information on an operation result accumulated through the operation through at least one quantum gate for each of at least one qubit (e.g., the first qubit, the second qubit, etc.).

In an embodiment, the quantum information (e.g., first quantum information, second quantum information, etc.) may include information on an initial value for each of at least one qubit (e.g., the first qubit, the second qubit, etc.).

The processor 110 composes first quantum states obtained by at least one first qubit, respectively into one by using a second quantum circuit that composes the first quantum states obtained for at least one first qubit, respectively into one to generate a first hash qubit including the first quantum states composed into one as a hash value (S120).

The second quantum circuit connects a third qubit and the first quantum states obtained for at least one first qubit, respectively by using at least one quantum state to compose the first quantum states obtained for at least one first qubit, respectively into one. For example, the second quantum circuit converts the third qubit and the first quantum states obtained for at least one first qubit, respectively into the entangled state by using the CNOT gate and/or the CZ gate to compose the first quantum states obtained for at least one first qubit, respectively into one.

Meanwhile, in an embodiment, the processor 110 may perform validation for a hash qubit.

For example, the processor 110 may obtain a first rotation value from the composed first quantum state included in a first hash qubit by using a predetermined first rotation algorithm.

The predetermined first rotation algorithm rotates the composed first quantum state to obtain the first rotation value from the composed first quantum state. For example, the predetermined first rotation algorithm may include an Euler rotation algorithm a, X-axis rotation algorithm, a Y-axis rotation algorithm, a Z-axis rotation algorithm, etc. The predetermined first rotation algorithm may include a quantum gate for rotating the composed first quantum state. Accordingly, the predetermined first rotation algorithm is applied to the quantum circuit to rotate the composed first quantum state and obtain the first rotation value.

The Euler rotation algorithm may be an algorithm that rotates the quantum state of the qubit by using three rotation axes (e.g., X axis, Y axis, Z axis, etc.). For example, the Euler rotation algorithm may be an algorithm that rotates the quantum state by designating a rotational angle for each axis. The X-axis rotation algorithm may be an algorithm that rotates the quantum state of the qubit based on the X axis. The Y-axis rotation algorithm may be an algorithm that rotates the quantum state of the qubit based on the Y axis. The Z-axis rotation algorithm may be an algorithm that rotates the quantum state of the qubit based on the Z axis.

In an embodiment, the first rotation algorithm may be determined to correspond to the composed first quantum state. For example, the processor 110 may determine the first rotation algorithm that operates the composed first quantum state to be measured as a specific value (e.g., 0 or 1) among a plurality of rotation algorithms.

In an embodiment, the first rotation algorithm may be predetermined according to the quantum state, and stored in the memory 130 of the computing device 100. Accordingly, the processor 110 may use the predetermined first rotation algorithm corresponding to the composed first quantum state.

The processor 110 may validate the first hash qubit based on whether the first rotation value and a predetermined first ground truth value correspond to each other. The predetermined first ground truth value may be determined as 0 or 1 based on the predetermined first rotation algorithm. The processor 110 may determine that the first hash qubit is not manipulated when the first rotation value and the predetermined first ground truth value correspond to each other. That is, the processor 110 may determine that the integrity for the first hash qubit is ensured when the first rotation value and the predetermined first ground truth value correspond to each other. The processor 110 may determine that the first hash qubit is manipulated when the first rotation value and the predetermined first ground truth value do not correspond to each other. That is, the processor 110 may determine that the integrity for the first hash qubit is not ensured when the first rotation value and the predetermined first ground truth value do not correspond to each other.

Meanwhile, in an embodiment, when qubits are present as different groups in the computing device 100, the computing device 100 generates hash qubits for each group, and composes the hash qubits generated for each group into one to generate a composed hash qubit.

For example, the processor 110 performs an operation for at least one second qubit initialized, by using the first quantum circuit to obtain a second quantum state including second quantum information for each of at least one second qubit.

The processor 110 composes second quantum states obtained by at least one second qubit, respectively into one by using the second quantum circuit that composes the second quantum states obtained for at least one second qubit, respectively into one to generate a second hash qubit including the second quantum states composed into one as the hash value.

At least one first qubit and at least one second qubit may not be in the entangled state with each other. Accordingly, at least one first qubit and at least one second qubit may be different groups in the computing device 100.

The processor 110 composes the first hash qubit and the second hash qubit into one by using a third quantum circuit that composes the composed first quantum state and the composed second quantum state into one to generate a composed hash qubit including the composed first quantum state and the composed second quantum state as the hash value.

The third quantum circuit may correspond to the second quantum circuit. For example, the third quantum circuit connects the third qubit, and the composed first quantum state and the composed second quantum state by using at least one quantum gate to compose the composed first quantum state and the composed second quantum state into one. In an embodiment, the third quantum circuit converts the third qubit, and the composed first quantum state and the composed second quantum state into the entangled state by using the CNOT gate and/or the CZ gate to compose the composed first quantum state and the composed second quantum state into one.

The processor 110 may obtain a second rotation value from the composed first quantum state and the composed second quantum state included in the composed hash qubit by using a predetermined second rotation algorithm.

The predetermined second rotation algorithm rotates the composed first quantum state and the composed second quantum state to obtain the second rotation value from the composed first quantum state and the composed second quantum state. For example, the predetermined second rotation algorithm may include an Euler rotation algorithm a, X-axis rotation algorithm, a Y-axis rotation algorithm, a Z-axis rotation algorithm, etc. The predetermined second rotation algorithm may include a quantum gate for rotating the composed first quantum state. Accordingly, the predetermined second rotation algorithm is applied to the quantum circuit to rotate the composed first quantum state and the second quantum state, and obtain the second rotation value.

In an embodiment, the second rotation algorithm may be determined to correspond to the composed first quantum state and the composed second quantum state. For example, the processor 110 may determine the second rotation algorithm that operates the composed first quantum state and the composed second quantum state to be measured as a specific value (e.g., 0 or 1) among a plurality of rotation algorithms.

In an embodiment, the second rotation algorithm may be predetermined according to the quantum state, and stored in the memory 130 of the computing device 100. Accordingly, the processor 110 may use the predetermined first rotation algorithm corresponding to the composed first quantum state and the composed second quantum state.

The processor 110 may validate the composed hash qubit based on whether the second rotation value and a predetermined second ground truth value correspond to each other. The predetermined second ground truth value may be determined as 0 or 1 based on the predetermined second rotation algorithm. The processor 110 may determine that the composed hash qubit is not manipulated when the second rotation value and the predetermined second ground truth value correspond to each other. That is, the processor 110 may determine that the integrity for the composed hash qubit is ensured when the second rotation value and the predetermined second ground truth value do not correspond to each other. The processor 110 may determine that the composed hash qubit is manipulated when the second rotation value and the predetermined second ground truth value do not correspond to each other. That is, the processor 110 may determine that the integrity for the composed hash qubit is not ensured when the second rotation value and the predetermined second ground truth value do not correspond to each other.

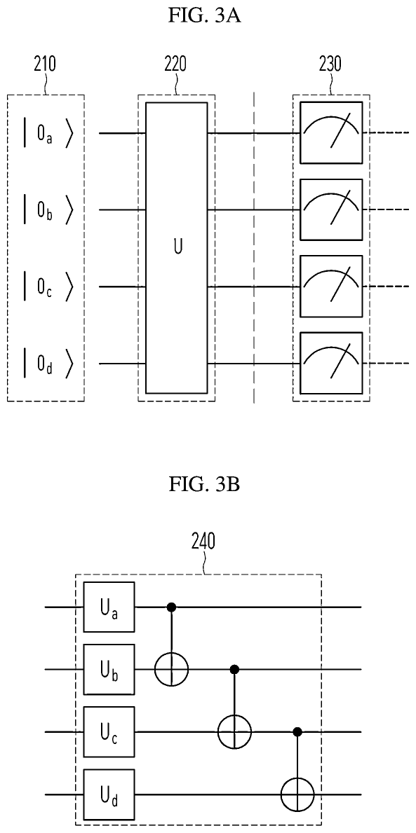

FIG. 3A is a diagram related to a first quantum circuit for ensuring the integrity of a quantum computer by the computing device according to an embodiment of the present disclosure. FIG. 3B is a diagram related to a first set of the first quantum circuit for ensuring the integrity of a quantum computer by the computing device according to an embodiment of the present disclosure.

Referring to FIG. 3A, the first quantum circuit may include at least one first qubit 210 initialized in the |0 [symbol] state, a first set 220 of the quantum gate, and a measurement 230. Referring to FIG. 3B, the first set 220 of the quantum gate may include a plurality of quantum gates 240. The plurality of quantum gates 240 includes a plurality of Hadamard gates, S gates, NOT gates (or Pauli-X gates), T gates, and the plurality of quantum gates may be expressed as a U gate in a diagram. Further, the plurality of quantum gates 240 may include CNOT gates, etc. However, the plurality of quantum gates 240 are not limited thereto and may include various quantum gates.

The first quantum circuit may initialize the qubit and change the state of the qubit, and perform an operation for each qubit or two or more qubits by using the quantum gate, and finish the operation through the measurement.

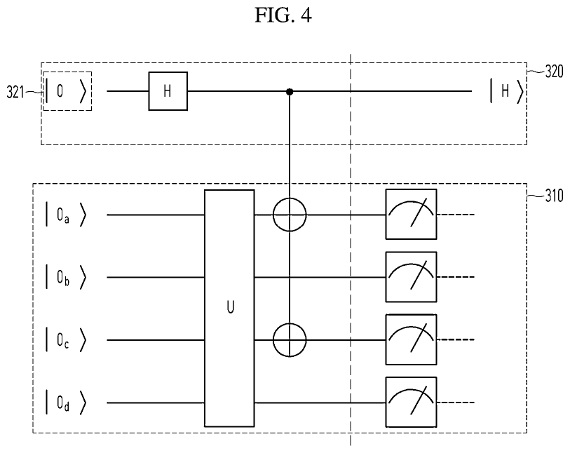

FIG. 4 is a diagram related to the first quantum circuit and a second quantum circuit for ensuring the integrity of a quantum computer by the computing device according to an embodiment of the present disclosure.

Referring to FIG. 4, an operation process using a first quantum circuit 310 may be expressed as in Equation 2 below, for example.

$$\vert ψ 〉 = {a}_{0} {b}_{0} {c}_{0} {d}_{0} \vert 0000 〉 + {a}_{0} {b}_{0} {c}_{0} {d}_{1} \vert 0001 〉 + {a}_{0} {b}_{0} {c}_{1} {d}_{1} \vert 0010 〉 + {a}_{0} {b}_{0} {c}_{1} {d}_{0} \vert 0011 〉 + {a}_{0} {b}_{1} {c}_{1} {d}_{0} \vert 0100 〉 + {a}_{0} {b}_{1} {c}_{1} {d}_{1} \vert 0101 〉 + {a}_{0} {b}_{1} {c}_{0} {d}_{1} \vert 0110 〉 + {a}_{0} {b}_{1} {c}_{0} {d}_{0} \vert 0111 〉 + {a}_{1} {b}_{1} {c}_{0} {d}_{0} \vert 1000 〉 + {a}_{1} {b}_{1} {c}_{0} {d}_{1} \vert 1001 〉 + {a}_{1} {b}_{1} {c}_{1} {d}_{1} \vert 1010 〉 + {a}_{1} {b}_{1} {c}_{1} {d}_{0} \vert 1011 〉 + {a}_{1} {b}_{0} {c}_{1} {d}_{0} \vert 1100 〉 + {a}_{1} {b}_{0} {c}_{1} {d}_{1} \vert 1101 〉 + {a}_{1} {b}_{0} {c}_{0} {d}_{1} \vert 1110 〉 + {a}_{1} {b}_{0} {c}_{0} {d}_{0} \vert 1111 〉 \qquad [ Equation 2 ]$$

In Equation 2, |ψ [symbol] may mean a prior-measurement state of the first quantum circuit 310. a, b, c, d may be first quantum information for each first qubit.

A second quantum circuit 320 may include one third qubit initialized in the |0 [symbol] state, and at least on quantum gate (e.g., the Hadamard gate, etc.).

The second quantum circuit 320 may be connected to the first quantum circuit 310 through the CNOT gate and/or the CZ gate. For example, a third qubit 321 and one qubit included in the first quantum circuit 310 may be connected through the CNOT gate. Accordingly, the second quantum circuit 320 converts the third qubit 321 and first quantum states obtained for at least one first qubit, respectively into the entangled state to compose the first quantum states obtained for at least one first qubit, respectively into one. The second quantum circuit 320 may not be connected to all qubits of the first quantum circuit 310, but connected only to two qubits among four qubits of the first quantum circuit 310. Accordingly, the computing device 100 may be connected to the first quantum circuit 310 efficiently by using the second quantum circuit 320, and may obtain the hash qubit without unnecessary manipulation and modification of the quantum computer.

A first hash qubit including the first quantum states composed into one as the hash value by using the second quantum circuit 320 may be identified by referring to Table 1 below, for example.

TABLE 1

| Index | Hash qubit state | Measurement value |
|---|---|---|
| H₀ | a₀b₀c₀d₀\|0 [symbol] + a₁b₁c₁d₁\|1 [symbol] | 0000 |
| H₁ | a₀b₀c₀d₁\|0 [symbol] + a₁b₁c₁d₀\|1 [symbol] | 0001 |
| H₂ | a₀b₀c₁d₁\|0 [symbol] + a₁b₁c₀d₀\|1 [symbol] | 0010 |
| H₃ | a₀b₀c₁d₀\|0 [symbol] + a₁b₁c₀d₁\|1 [symbol] | 0011 |
| H₄ | a₀b₁c₁d₀\|0 [symbol] + a₁b₀c₀d₁\|1 [symbol] | 0100 |
| H₅ | a₀b₁c₁d₁\|0 [symbol] + a₁b₀c₀d₀\|1 [symbol] | 0101 |
| H₆ | a₀b₁c₀d₁\|0 [symbol] + a₁b₀c₁d₀\|1 [symbol] | 0110 |
| H₇ | a₀b₁c₀d₀\|0 [symbol] + a₁b₀c₁d₁\|1 [symbol] | 0111 |
| H₈ | a₁b₁c₀d₀\|0 [symbol] + a₀b₀c₁d₁\|1 [symbol] | 1000 |
| H₉ | a₁b₁c₀d₁\|0 [symbol] + a₀b₀c₁d₀\|1 [symbol] | 1001 |
| H₁₀ | a₁b₁c₁d₁\|0 [symbol] + a₀b₀c₀d₀\|1 [symbol] | 1010 |
| H₁₁ | a₁b₁c₁d₀\|0 [symbol] + a₀b₀c₀d₁\|1 [symbol] | 1011 |
| H₁₂ | a₁b₀c₁d₀\|0 [symbol] + a₀b₁c₀d₁\|1 [symbol] | 1100 |
| H₁₃ | a₁b₀c₁d₁\|0 [symbol] + a₀b₁c₀d₀\|1 [symbol] | 1101 |
| H₁₄ | a₁b₀c₀d₁\|0 [symbol] + a₀b₁c₁d₀\|1 [symbol] | 1110 |
| H₁₅ | a₁b₀c₀d₀\|0 [symbol] + a₀b₁c₁d₁\|1 [symbol] | 1111 |

In Table 1, a measurement value is an operation result of the first quantum circuit 310, and has the first hash qubit according to each operation result. All first hash qubits may include all first quantum information for respective first qubits.

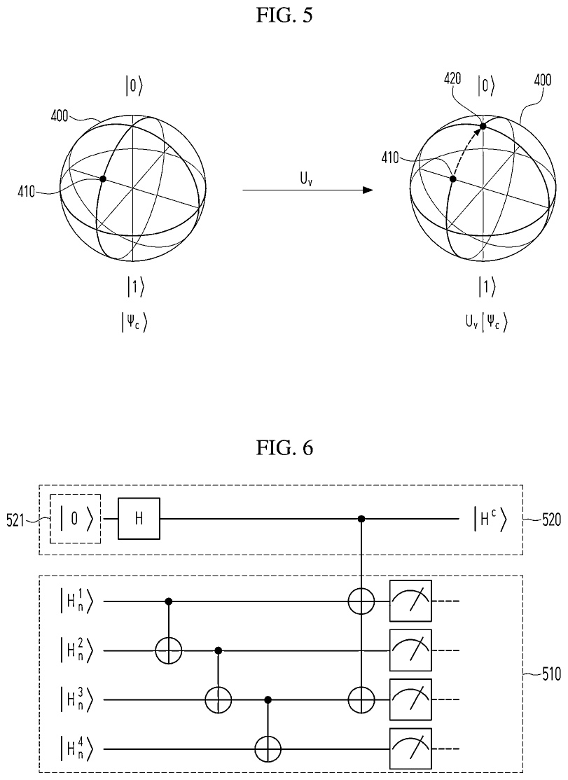

FIG. 5 is a flowchart illustrating a validation process of a hash qubit for ensuring the integrity of a quantum computer, which is performed by the computing device according to an embodiment of the present disclosure.

Referring to FIG. 5, the processor 110 may identify a quantum state 410 of a qubit (e.g., a hash qubit |ψ_{c} [symbol] ) on a Bloch sphere 400 by using the Bloch sphere 400.

The processor 110 may obtain a first rotation value 420 from the quantum state 410 of the hash qubit by using a predetermined rotation algorithm (e.g., a first rotation algorithm, a second rotation algorithm, etc.) Uᵥ. In an embodiment of the present disclosure, the predetermined rotation algorithm Uᵥ may be expressed as in Equation 3 below.

$${U}_{v} = Euler Rotation with ( {c}_{1} , {c}_{2} , {c}_{3} ) angles \\ α sin ( \frac{{c}_{2}}{2} ) ( cos ( \frac{{c}_{1} - {c}_{3}}{2} ) + i sin ( \frac{{c}_{1} - {c}_{3}}{2} ) ) + β cos ( \frac{{c}_{2}}{2} ) ( cos ( \frac{{c}_{1} + {c}_{3}}{2} ) + i sin ( \frac{{c}_{1} + {c}_{3}}{2} ) ) = 0 \qquad [ Equation 3 ]$$

In Equation 3, C₁ may represent a cosine value for the X axis, C₂ may represent a cosine value for the Y axis, C₃ may represent a cosine value for the Z axis, α may represent a rotational angle of the X axis, β may represent a rotational angle of the Y axis, and i may represent a rotational angle of the Z axis.

FIG. 6 is a diagram related to the first quantum circuit and a third quantum circuit for ensuring the integrity of a quantum computer by the computing device according to an embodiment of the present disclosure.

Referring to FIG. 6, a first quantum circuit 510 may include a plurality of hash qubits |Hₙ¹ [symbol] , |Hₙ² [symbol] , |Hₙ³ [symbol] , |Hₙ⁴ [symbol] each having n first quantum information, a quantum gate, and a measurement. A quantum gate of the first quantum circuit 510 may include the CNOT gate.

A third quantum circuit 520 may include a third qubit 521 initialized in the | state, and at least on quantum gate (e.g., the Hadamard gate, etc.).

The third quantum circuit 520 may be connected to the first quantum circuit 510 through the CNOT gate and/or the CZ gate. For example, the third qubit 521 and one hash qubit included in the first quantum circuit 510 may be connected through the CNOT gate. Accordingly, the third quantum circuit 520 converts the third qubit, and the composed first quantum state and the composed second quantum state into the entangled state to compose the composed first quantum state and the composed second quantum state into one. The third quantum circuit 520 may not connect the third qubit to all qubits of the first quantum circuit 510, but connect the third qubit 321 only to two hash qubits among four hash qubits of the first quantum circuit 510. Accordingly, the computing device 100 may be connected to the first quantum circuit 510 efficiently by using the third quantum circuit 520, and may obtain the composed hash qubit without unnecessary manipulation and modification of the quantum computer.

A result of the composed hash qubit generated by using the third quantum circuit 520 may be identified by using Table 1 above, for example.

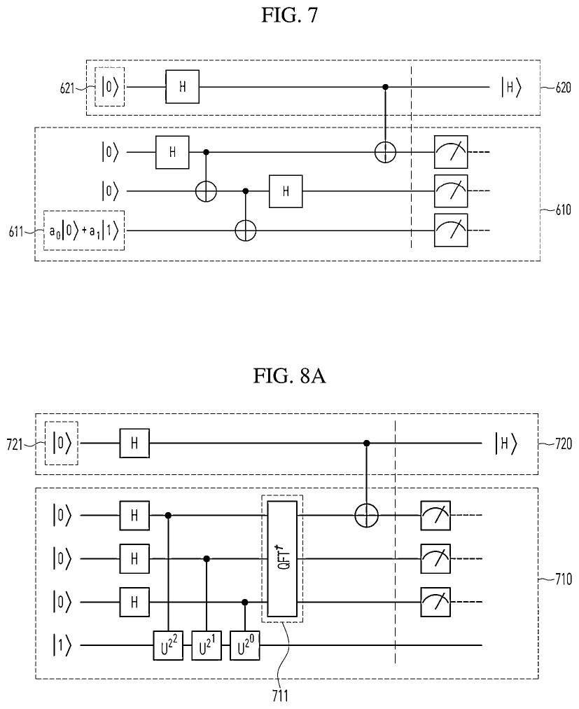

FIG. 7 is a diagram related to a first quantum circuit and a third quantum circuit for ensuring the integrity of a quantum computer by a computing device according to another embodiment of the present disclosure.

Referring to FIG. 7, a first quantum circuit 610 may include three qubits, a quantum gate, and a measurement. A quantum gate of the first quantum circuit 610 may include the Hadamard gate and the CNOT gate.

In the first quantum gate 610, any one qubit 611 among three qubits may be α₀|0 [symbol] +α₁|1 [symbol] having quantum information.

A third quantum circuit 620 may include a third qubit 621 initialized in the |0 [symbol] state, and at least on quantum gate.

At least one quantum gate of the third quantum circuit 620 may include the Hadamard gate.

The measurement may be performed by the first quantum circuit 610.

A hash qubit |H [symbol] of the first quantum state may be identified by referring to Table 2 below.

TABLE 2

| Index | Hash qubit state | Measurement value |
|---|---|---|
| H₀ | a₀\|0 [symbol] + a₁\|1 [symbol] | 000 |
| H₁ | a₁\|0 [symbol] + a₀\|1 [symbol] | 001 |
| H₂ | a₀\|0 [symbol] − a₁\|1 [symbol] | 010 |
| H₃ | a₁\|0 [symbol] − a₀\|1 [symbol] | 011 |
| H₄ | a₁\|0 [symbol] + a₀\|1 [symbol] | 100 |
| H₅ | a₀\|0 [symbol] + a₁\|1 [symbol] | 101 |
| H₆ | a₁\|0 [symbol] − a₀\|1 [symbol] | 110 |
| H₇ | a₀\|0 [symbol] − a₁\|1 [symbol] | 111 |

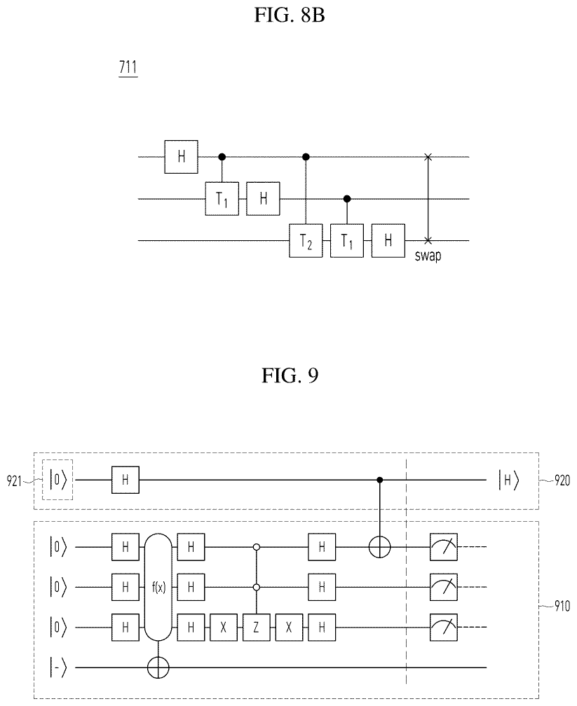

FIG. 8A is a diagram related to a first quantum circuit and a third quantum circuit for ensuring the integrity of a quantum computer by a computing device according to yet another embodiment of the present disclosure. FIG. 8B is a diagram related to a second set of the first quantum circuit for ensuring the integrity of a quantum computer by the computing device according to yet another embodiment of the present disclosure.

Referring to FIG. 8A, a first quantum circuit 710 may include four qubits, a quantum gate, and a measurement.

A quantum gate of the first quantum circuit 710 may include the Hadamard gate, the CNOT gate, the U gate, and a second set (QFTⁱ) 711 of the quantum gate. Here the U gate includes information ϕ which the first quantum circuit 710 intends to operate.

Referring to FIG. 8B, the second set (QFTⁱ) 711 of the quantum gate may include the Hadamard gate, the T gate, the SWAP gate, etc.

Referring back to FIG. 8A, a third quantum circuit 720 may include a third qubit 721 initialized in the |0 [symbol] state, and at least on quantum gate.

At least one quantum gate of the third quantum circuit 720 may include the Hadamard gate.

The measurement may be performed by the first quantum circuit 710.

A hash qubit |H [symbol] of the first quantum state may be expressed as in Equation 4

[symbol]

$$\vert {H}_{0} 〉 = \frac{1}{8 \sqrt{2}} ( 1 + {e}^{i ϕ} + {e}^{2 i ϕ} + {e}^{3 i ϕ} … + {e}^{6 i ϕ} + {e}^{7 i ϕ} ) \vert 0 〉 + \frac{1}{8 \sqrt{2}} ( 1 - {e}^{i ϕ} + {e}^{2 i ϕ} - {e}^{3 i ϕ} … + {e}^{6 i ϕ} - {e}^{7 i ϕ} ) \vert 1 〉 \qquad [ Equation 4 ]$$

$$( Measurement value = 000 )$$

In Equation 4, |H [symbol] may be a state of the hash qubit when a measurement value of the first quantum circuit 710 is ‘000’. ϕ may be a result value which the first quantum circuit 710 intends to obtain by an original algorithm.

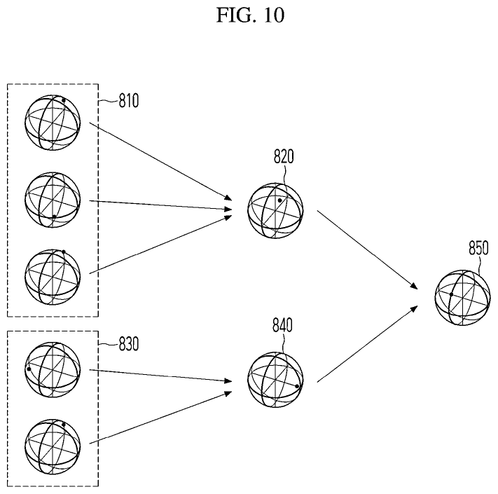

FIG. 9 is a diagram related to a first quantum circuit and the third quantum circuit for ensuring the integrity of a quantum computer by the computing device according to yet another embodiment of the present disclosure.

Referring to FIG. 9, a first quantum circuit 910 may include four qubits, a quantum gate, and a measurement.

A quantum gate of the first quantum circuit 910 may include the Hadamard gate, the Pauli-X gate, the CNOT gate, the CZ gate, a f(x) oracle gate, etc. The f(x) oracle gate as an oracle implemented by the quantum circuit may be a gate that returns the value of 1 only with respect to specific x.

A third quantum circuit 920 may include a third qubit 921 initialized in the |0 [symbol] state, and at least on quantum gate.

At least one quantum gate of the third quantum circuit 920 may include the Hadamard gate.

The measurement may be performed by the first quantum circuit 910.

When the oracle gate is f(x)=1, x=(=000)₂, the hash qubit |H [symbol] of the first quantum state may be identified by referring to Table 3 below.

TABLE 3

| Index | Hash qubit state | Measurement value | Probability |
|---|---|---|---|
| H₀ | $- \frac{5}{2 \sqrt{13}} \vert 0 〉 - \frac{1}{2 \sqrt{13}} \vert 1 〉$ | 000 | $\frac{13}{32}$ |
| H₁ | $- \frac{1}{2} \vert 0 〉 - \frac{1}{2} \vert 1 〉$ | 001 | $\frac{1}{32}$ |
| H₂ | $- \frac{1}{2} \vert 0 〉 - \frac{1}{2} \vert 1 〉$ | 010 | $\frac{1}{32}$ |
| H₃ | $- \frac{1}{2} \vert 0 〉 - \frac{1}{2} \vert 1 〉$ | 011 | $\frac{1}{32}$ |
| H₄ | $- \frac{1}{2 \sqrt{13}} \vert 0 〉 - \frac{5}{2 \sqrt{13}} \vert 1 〉$ | 100 | $\frac{13}{32}$ |
| H₅ | $- \frac{1}{2} \vert 0 〉 - \frac{1}{2} \vert 1 〉$ | 101 | $\frac{1}{32}$ |
| H₆ | $- \frac{1}{2} \vert 0 〉 - \frac{1}{2} \vert 1 〉$ | 110 | $\frac{1}{32}$ |
| H₇ | $- \frac{1}{2} \vert 0 〉 - \frac{1}{2} \vert 1 〉$ | 111 | $\frac{1}{32}$ |

FIG. 10 is a diagram related to a process of generating a composite hash qubit for ensuring the integrity of a quantum computer by the computing device according to an embodiment of the present disclosure.

Referring to FIG. 10, the processor 110 may generate a first hash qubit 820 in which quantum states for at least one first qubit 810 obtained using the first quantum circuit are composed into one by using the second quantum circuit.

The processor 110 may generate a second hash qubit 840 in which quantum states for at least one second qubit 830 obtained using the first quantum circuit are composed into one by using the second quantum circuit.

The processing 110 composes the first hash qubit 820 and the second hash qubit 830 into one by using the third quantum circuit to generate a composed hash qubit 850 including a composed first quantum state of the first hash qubit 820 and a composed second quantum state of the second hash qubit 830 as a hash value.

The composed hash qubit 850 may have all quantum information regardless of the size and the entangled state of a target quantum computer. Accordingly, the computing device 100 may ensure the integrity of the quantum computer with a value of the composed hash qubit 850.

The computing device 100 according to an embodiment of the present disclosure described above through FIGS. 1 to 10 may ensure the integrity for the quantum computer by using the hash qubit and the composed hash qubit. Accordingly, the computing device 100 according to an embodiment of the present disclosure enables the quantum computer to be handled as a quantum evidence, and may prove an ability of a quantum computer related evidence in a court, etc. Therefore, the computing device 100 according to an embodiment of the present disclosure may be used as a scientific investigation technology for crimes using the quantum computer in investigative agencies, etc.

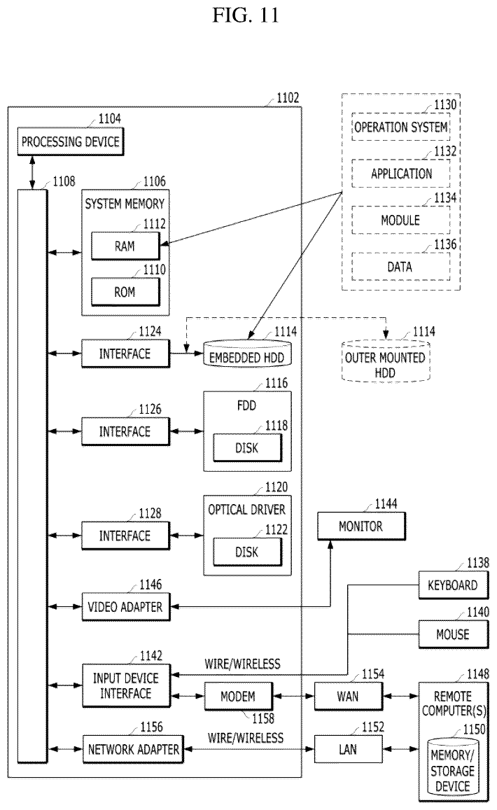

FIG. 11 is a normal and schematic view of an exemplary computing environment in which the exemplary embodiments of the present disclosure may be implemented.

It is described above that the present disclosure may be generally implemented by the computing device, but those skilled in the art will well know that the present disclosure may be implemented in association with a computer executable command which may be executed on one or more computers and/or in combination with other program modules and/or a combination of hardware and software.

In general, the program module includes a routine, a program, a component, a data structure, and the like that execute a specific task or implement a specific abstract data type. Further, it will be well appreciated by those skilled in the art that the method of the present disclosure can be implemented by other computer system configurations including a personal computer, a handheld computing device, microprocessor-based or programmable home appliances, and others (the respective devices may operate in connection with one or more associated devices as well as a single-processor or multi-processor computer system, a mini computer, and a main frame computer.

The exemplary embodiments described in the present disclosure may also be implemented in a distributed computing environment in which predetermined tasks are performed by remote processing devices connected through a communication network. In the distributed computing environment, the program module may be positioned in both local and remote memory storage devices.

The computer generally includes various computer readable media. Media accessible by the computer may be computer readable media regardless of types thereof and the computer readable media include volatile and non-volatile media, transitory and non-transitory media, and mobile and non-mobile media. As a non-limiting example, the computer readable media may include both computer readable storage media and computer readable transmission media. The computer readable storage media include volatile and non-volatile media, transitory and non-transitory media, and mobile and non-mobile media implemented by a predetermined method or technology for storing information such as a computer readable instruction, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The computer readable transmission media generally implement the computer readable command, the data structure, the program module, or other data in a carrier wave or a modulated data signal such as other transport mechanism and include all information transfer media. The term “modulated data signal” means a signal acquired by setting or changing at least one of characteristics of the signal so as to encode information in the signal. As a non-limiting example, the computer readable transmission media include wired media such as a wired network or a direct-wired connection and wireless media such as acoustic, RF, infrared and other wireless media. A combination of any media among the aforementioned media is also included in a range of the computer readable transmission media.

An exemplary environment that implements various aspects of the present disclosure including a computer 1102 is shown and the computer 1102 includes a processing device 1104, a system memory 1106, and a system bus 1108. The system bus 1108 connects system components including the system memory 1106 (not limited thereto) to the processing device 1104. The processing device 1104 may be a predetermined processor among various commercial processors. A dual processor and other multi-processor architectures may also be used as the processing device 1104.

The system bus 1108 may be any one of several types of bus structures which may be additionally interconnected to a local bus using any one of a memory bus, a peripheral device bus, and various commercial bus architectures. The system memory 1106 includes a read only memory (ROM) 1110 and a random access memory (RAM) 1112. A basic input/output system (BIOS) is stored in the non-volatile memories 1110 including the ROM, the EPROM, the EEPROM, and the like and the BIOS includes a basic routine that assists in transmitting information among components in the computer 1102 at a time such as in-starting. The RAM 1112 may also include a high-speed RAM including a static RAM for caching data, and the like.

The computer 1102 also includes an interior hard disk drive (HDD) 1114 (for example, EIDE and SATA), in which the interior hard disk drive 1114 may also be configured for an exterior purpose in an appropriate chassis (not illustrated), a magnetic floppy disk drive (FDD) 1116 (for example, for reading from or writing in a mobile diskette 1118), and an optical disk drive 1120 (for example, for reading a CD-ROM disk 1122 or reading from or writing in other high-capacity optical media such as the DVD, and the like). The hard disk drive 1114, the magnetic disk drive 1116, and the optical disk drive 1120 may be connected to the system bus 1108 by a hard disk drive interface 1124, a magnetic disk drive interface 1126, and an optical drive interface 1128, respectively. An interface 1124 for implementing an exterior drive includes at least one of a universal serial bus (USB) and an IEEE 1394 interface technology or both of them.

The drives and the computer readable media associated therewith provide non-volatile storage of the data, the data structure, the computer executable instruction, and others. In the case of the computer 1102, the drives and the media correspond to storing of predetermined data in an appropriate digital format. In the description of the computer readable media, the mobile optical media such as the HDD, the mobile magnetic disk, and the CD or the DVD are mentioned, but it will be well appreciated by those skilled in the art that other types of media readable by the computer such as a zip drive, a magnetic cassette, a flash memory card, a cartridge, and others may also be used in an exemplary operating environment and further, the predetermined media may include computer executable commands for executing the methods of the present disclosure.

Multiple program modules including an operating system 1130, one or more application programs 1132, other program module 1134, and program data 1136 may be stored in the drive and the RAM 1112. All or some of the operating system, the application, the module, and/or the data may also be cached in the RAM 1112. It will be well appreciated that the present disclosure may be implemented in operating systems which are commercially usable or a combination of the operating systems.

A user may input instructions and information in the computer 1102 through one or more wired/wireless input devices, for example, pointing devices such as a keyboard 1138 and a mouse 1140. Other input devices (not illustrated) may include a microphone, an IR remote controller, a joystick, a game pad, a stylus pen, a touch screen, and others. These and other input devices are often connected to the processing device 1104 through an input device interface 1142 connected to the system bus 1108, but may be connected by other interfaces including a parallel port, an IEEE 1394 serial port, a game port, a USB port, an IR interface, and others.

A monitor 1144 or other types of display devices are also connected to the system bus 1108 through interfaces such as a video adapter 1146, and the like. In addition to the monitor 1144, the computer generally includes other peripheral output devices (not illustrated) such as a speaker, a printer, others.

The computer 1102 may operate in a networked environment by using a logical connection to one or more remote computers including remote computer(s) 1148 through wired and/or wireless communication. The remote computer(s) 1148 may be a workstation, a computing device computer, a router, a personal computer, a portable computer, a micro-processor based entertainment apparatus, a peer device, or other general network nodes and generally includes multiple components or all of the components described with respect to the computer 1102, but only a memory storage device 1150 is illustrated for brief description. The illustrated logical connection includes a wired/wireless connection to a local area network (LAN) 1152 and/or a larger network, for example, a wide area network (WAN) 1154. The LAN and WAN networking environments are general environments in offices and companies and facilitate an enterprise-wide computer network such as Intranet, and all of them may be connected to a worldwide computer network, for example, the Internet.

When the computer 1102 is used in the LAN networking environment, the computer 1102 is connected to a local network 1152 through a wired and/or wireless communication network interface or an adapter 1156. The adapter 1156 may facilitate the wired or wireless communication to the LAN 1152 and the LAN 1152 also includes a wireless access point installed therein in order to communicate with the wireless adapter 1156. When the computer 1102 is used in the WAN networking environment, the computer 1102 may include a modem 1158 or has other means that configure communication through the WAN 1154 such as connection to a communication computing device on the WAN 1154 or connection through the Internet. The modem 1158 which may be an internal or external and wired or wireless device is connected to the system bus 1108 through the serial port interface 1142. In the networked environment, the program modules described with respect to the computer 1102 or some thereof may be stored in the remote memory/storage device 1150. It will be well known that an illustrated network connection is exemplary and other means configuring a communication link among computers may be used.

The computer 1102 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and Bluetooth wireless technology. Accordingly, communication may be a predefined structure like the network in the related art or just ad hoc communication between at least two devices.

The wireless fidelity (Wi-Fi) enables connection to the Internet, and the like without a wired cable. The Wi-Fi is a wireless technology such as the device, for example, a cellular phone which enables the computer to transmit and receive data indoors or outdoors, that is, anywhere in a communication range of a base station. The Wi-Fi network uses a wireless technology called IEEE 802.11 (a, b, g, and others) in order to provide safe, reliable, and high-speed wireless connection. The Wi-Fi may be used to connect the computers to each other or the Internet and the wired network (using IEEE 802.3 or Ethernet). The Wi-Fi network may operate, for example, at a data rate of 11 Mbps (802.11a) or 54 Mbps (802.11b) in unlicensed 2.4 and 5 GHz wireless bands or operate in a product including both bands (dual bands).

It will be appreciated by those skilled in the art that information and signals may be expressed by using various different predetermined technologies and techniques. For example, data, instructions, commands, information, signals, bits, symbols, and chips which may be referred in the above description may be expressed by voltages, currents, electromagnetic waves, magnetic fields or particles, optical fields or particles, or predetermined combinations thereof.

It may be appreciated by those skilled in the art that various exemplary logical blocks, modules, processors, means, circuits, and algorithm steps described in association with the exemplary embodiments disclosed herein may be implemented by electronic hardware, various types of programs or design codes (for easy description, herein, designated as software), or a combination of all of them. In order to clearly describe the inter compatibility of the hardware and the software, various exemplary components, blocks, modules, circuits, and steps have been generally described above in association with functions thereof. Whether the functions are implemented as the hardware or software depends on design restrictions given to a specific application and an entire system. Those skilled in the art of the present disclosure may implement functions described by various methods with respect to each specific application, but it should not be interpreted that the implementation determination departs from the scope of the present disclosure.

Various exemplary embodiments presented herein may be implemented as manufactured articles using a method, a device, or a standard programming and/or engineering technique. The term manufactured article includes a computer program, a carrier, or a medium which is accessible by a predetermined computer-readable storage device. For example, a computer-readable storage medium includes a magnetic storage device (for example, a hard disk, a floppy disk, a magnetic strip, or the like), an optical disk (for example, a CD, a DVD, or the like), a smart card, and a flash memory device (for example, an EEPROM, a card, a stick, a key drive, or the like), but is not limited thereto. Further, various storage media presented herein include one or more devices and/or other machine-readable media for storing information.

It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Appended method claims provide elements of various steps in a sample order, but the method claims are not limited to the presented specific order or hierarchical structure.

The description of the presented exemplary embodiments is provided so that those skilled in the art of the present disclosure use or implement the present disclosure. Various modifications of the exemplary embodiments will be apparent to those skilled in the art and general principles defined herein can be applied to other exemplary embodiments without departing from the scope of the present disclosure. Therefore, the present disclosure is not limited to the exemplary embodiments presented herein, but should be interpreted within the widest range which is coherent with the principles and new features presented herein.

1. A method for ensuring the integrity of a quantum computer, which is performed by a computing device including the quantum computer, the method comprising:
performing an operation for at least one first qubit initialized, by using a first quantum circuit including at least one quantitative gate to obtain a first quantum state including first quantum information for each of the at least one first qubit; and
composing first quantum states obtained for the at least one first qubit, respectively into one by using a second quantum circuit that composes the first quantum states obtained for the at least one first qubit, respectively into one to generate a first hash qubit including the first quantum states composed into one as a hash value.

2. The method of claim 1, wherein the first quantum information includes information on a spin for each of the at least one first qubit.

3. The method of claim 1, wherein the first quantum information includes information on an operation result accumulated by an operation through the at least one quantum gate with respect to each of the at least one first qubit.

4. The method of claim 1, further comprising:
obtaining a first rotation value from the composed first quantum state included in the first hash qubit by using a predetermined first rotation algorithm; and
validating the first hash qubit based on whether the first rotation value and a predetermined first ground truth value correspond to each other.

5. The method of claim 4, wherein the first predetermined first ground truth value is determined as 0 or 1 based on the predetermined first rotation algorithm.

6. The method of claim 1, further comprising:
performing an operation for at least one second qubit initialized, by using the first quantum circuit to obtain a second quantum state including second quantum information for each of the at least one second qubit; and
composing second quantum states obtained for the at least one second qubit, respectively into one by using the second quantum circuit that composes the second quantum states obtained for the at least one second qubit, respectively into one to generate a second hash qubit including the second quantum states composed into one as the hash value,
wherein the at least one first qubit and the at least one second qubit are not in an entangled state with each other.

7. The method of claim 6, further comprising:
composing the first hash qubit and the second hash qubit into one by using a third quantum circuit that composes the composed first quantum state and the composed second quantum state into one to generate a composed hash qubit including the composed first quantum state and the composed second quantum state as the hash value.

8. The method of claim 7, wherein the second quantum circuit and the third quantum circuit correspond to each other.

9. The method of claim 7, further comprising:
obtaining a second rotation value from the composed first quantum state and the composed second quantum state included in the composed hash qubit by using a predetermined second rotation algorithm; and
validating the composed hash qubit based on whether the second rotation value and a predetermined second ground truth value correspond to each other.

10. The method of claim 9, wherein the predetermined second ground truth value is determined as 0 or 1 based on the predetermined second rotation algorithm.

11. The method of claim 1, wherein the second quantum circuit connects a third qubit and the first quantum states obtained for the at least one first qubit, respectively by using at least one quantum state to compose the first quantum states obtained for the at least one first qubit, respectively into one.

12. A computer program storing non-transitory computer readable storage medium, wherein the computer program comprises instructions for causing a processor of a computing device including a quantum computer to perform the following steps for ensuring the integrity for the quantum computer, the steps comprising:
performing an operation for at least one first qubit initialized, by using a first quantum circuit including at least one quantitative gate to obtain a first quantum state including first quantum information for each of the at least one first qubit; and
composing first quantum states obtained for the at least one first qubit, respectively into one by using a second quantum circuit that composes the first quantum states obtained for the at least one first qubit, respectively into one to generate a first hash qubit including the first quantum states composed into one as a hash value.

13. A computing device including a quantum computer, for ensuring the integrity of the quantum computer, comprising:
a processor; and
a memory,
wherein the processor
performs an operation for at least one first qubit initialized, by using a first quantum circuit including at least one quantitative gate to obtain a first quantum state including first quantum information for each of the at least one first qubit, and
composes first quantum states obtained for the at least one first qubit, respectively into one by using a second quantum circuit that composes the first quantum states obtained for the at least one first qubit, respectively into one to generate a first hash qubit including the first quantum states composed into one as a hash value.
